(19) United States
(12) Patent Application Publication
(10) Pub. No.: US 2022/0190447 A1
(43) Pub. Date: Jun. 16, 2022

(54) LEAD MEMBER

(71) Applicant: SUMITOMO ELECTRIC INDUSTRIES, LTD., Osaka (JP)

(72) Inventors: Takashi SHIMAMURA, Tochigi (JP); Kengo GOTO, Osaka (JP); Yusuke KUREISHI, Osaka (JP); Akihisa HOSOE, Osaka (JP)

(21) Appl. No.: 17/262,871

(22) PCT Filed: Jun. 10, 2020
(86) PCT No.: PCT/JP2020/022881

§ 371 Date: Jan. 25, 2021

(51) Int. Cl. H01M 50/534; C25D 11/14

(52) U.S. Cl. CPC H01M 50/534; C25D 11/14

(57) ABSTRACT

A lead member includes: a lead conductor having a first main surface and a second main surface that is an opposite side of the first main surface; and a resin portion, while exposing both end portions of the lead conductor in a first direction, covering the first main surface, the second main surface, and both side surfaces between the both end portions of the lead conductor, wherein the lead conductor includes a metal substrate, and a colored layer formed on at least a portion of a surface of the metal substrate, wherein in an entire wavelength band of 220 nm or more and 850 nm or less, when a total reflectance of barium sulfate is defined as 1.0, a regular reflectance of the colored layer is 0.3 or less.

### TECHNICAL FIELD

The present disclosure relates to a lead member.

### BACKGROUND ART

A non-aqueous electrolyte battery, such as a lithium ion battery, has a structure in which the positive electrode, the negative electrode, and an electrolyte solution are enclosed in an inclusion body made of a layered film, and a lead member (tab lead) connected to the positive electrode and the negative electrode is sealed and taken out. A lead member is configured by welding, to an area other than both ends in the longitudinal direction of an aluminum lead conductor for a positive electrode or a nickel or nickel-plated copper lead conductor for a negative electrode, a multi-layer sealant film made of a resin film, such as polypropylene (PP) from both surfaces.

Patent Document 1 discloses a tab lead continuous body in which a colored tape is attached to an insulating film at a defective location.

### PRIOR ART DOCUMENT

### Patent Document

[Patent Document 1] Japanese Laid-open Patent Publication No. 2010-218752

### SUMMARY OF THE INVENTION

According to the present disclosure, a lead member includes: a lead conductor having a first main surface and a second main surface that is an opposite side of the first main surface; and a resin portion, while exposing both end portions of the lead conductor in a first direction, covering the first main surface, the second main surface, and both side surfaces between the both end portions of the lead conductor. The lead conductor includes a metal substrate, and a colored layer formed on at least a portion of a surface of the metal substrate. In an entire wavelength band of 220 nm or more and 850 nm or less, when a total reflectance of barium sulfate is defined as 1.0, a regular reflectance of the colored layer is 0.3 or less.

### BRIEF DESCRIPTION OF THE DRAWINGS

FIG. 1 is a plan view illustrating a lead member according to a first embodiment;

FIG. 2 is a cross-sectional view (part 1) illustrating the lead member according to the first embodiment;

FIG. 3 is a cross-sectional view (Part 2) illustrating the lead member according to the first embodiment;

FIG. 4 is a schematic diagram illustrating a black nickel-plating layer;

FIG. 5 is a plan view (part 1) illustrating a method of manufacturing a lead member according to the first embodiment;

FIG. 6 is a plan view (part 2) illustrating the method of manufacturing the lead member according to the first embodiment;

FIG. 7 is a plan view (part 3) illustrating the method of manufacturing the lead member according to the first embodiment;

FIG. 8 is a plan view (part 4) illustrating the method of manufacturing the lead member according to the first embodiment;

FIG. 9 is a plan view illustrating a lead member according to a second embodiment; and

FIG. 10 is a cross-sectional view illustrating the lead member according to the second embodiment.

### EMBODIMENT FOR CARRYING OUT THE INVENTION

### Problem to Be Solved by the Present Disclosure

According to the technique disclosed in Patent Document 1, although the intended purpose is achieved, it is difficult to visually find a flaw that occurs on a lead conductor.

### Effect of the Present Disclosure

According to the present disclosure, it is easy to visually find a flaw that occurs on a lead conductor.

An embodiment for carrying out will be described below.

### DESCRIPTION OF EMBODIMENT OF THE PRESENT DISCLOSURE

To begin with, aspects of the present disclosure are listed and described below. In the following description, the same reference characters are allotted to the same or corresponding elements and the same descriptions thereof are not repeated.

<1> According to one aspect of the present disclosure, a lead member includes: a lead conductor having a first main surface and a second main surface that is an opposite side of the first main surface; and a resin portion, while exposing both end portions of the lead conductor in a first direction, covering the first main surface, the second main surface, and both side surfaces between the both end portions of the lead conductor, wherein the lead conductor includes a metal substrate, and a colored layer formed on at least a portion of a surface of the metal substrate, wherein in an entire wavelength band of 220 nm or more and 850 nm or less, when a total reflectance of barium sulfate is defined as 1.0, a regular reflectance of the colored layer is 0.3 or less.

In the lead member according to one aspect of the present disclosure, when the total reflectance of barium sulfate is defined as 1.0, the colored layer having a regular reflectance of 0.3 or less is formed on the surface of the metal substrate of the lead conductor. Therefore, when a flaw is formed on the colored layer, it is easy to find the flaw visually.

<2> According to <1>, The metal substrate may include aluminum, an aluminum alloy, nickel, a nickel alloy, copper, a copper alloy, nickel-plated aluminum, a nickel-plated aluminum alloy, nickel clad aluminum, a nickel clad aluminum alloy, nickel-plated copper, a nickel-plated copper alloy, nickel clad copper, or a nickel clad copper alloy. In this case, a lead conductor with good electrical conductivity is easily obtained.

<3> According to <2>, the metal substrate may be made of aluminum or an aluminum alloy, and the colored layer may include a black anodic oxide coating. In this case, a colored layer that enables to easily find a flaw can be easily formed.

<4> According to <3>, in the entire wavelength band of 220 nm or more and 850 nm or less, when the total reflectance of the barium sulfate is defined as 1.0, a regular reflectance of the black anodic oxide coating may be 0.2 or less. In this case, a flaw can be found further easily.

<5> According to <2>, the metal substrate may be made of nickel-plated aluminum, a nickel-plated aluminum alloy, nickel-plated copper, or a nickel-plated copper alloy, and the colored layer may include a black nickel-plating layer having an arithmetic mean peak curvature Spc of 5000 mm⁻¹ or more that is measured in accordance with ISO 25178. In this case, a colored layer that enables to easily find a flaw can be easily formed.

<6> According to <5>, in the entire wavelength band of 220 nm or more and 850 nm or less, when the total reflectance of the barium sulfate is defined as 1.0, a regular reflectance of the black nickel-plating layer may be 0.2 or less. In this case, a flaw can be found further easily.

<7> According to <2>, the metal substrate may be made of nickel, a nickel alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy, and the colored layer may include a black chrome-plating layer. In this case, a colored layer that enables to easily find a flaw can be easily formed.

<8> According to <7>, in the entire wavelength band of 220 nm or more and 850 nm or less, when the total reflectance of the barium sulfate is defined as 1.0, a regular reflectance of the black chrome-plating layer may be 0.2 or less. In this case, a flaw can be found further easily.

<9> According to <1> to <8>, the colored layer may be provided at least between the metal substrate and the resin portion. In this case, in a case of being used for a non-aqueous electrolyte battery, it is easy to suppress leakage of an electrolytic solution.

<10> According to <1> to <9>, the colored layer may be provided on an entirety of the first main surface and the second main surface. In this case, it is easy to detect a flaw over a wide area.

<11> According to <1> to <10>, the resin portion may include polypropylene. In this case, the resin portion is easily heat-fused to the lead conductor.

<12> According to another aspect of the present disclosure, a lead member includes: a lead conductor having a first main surface and a second main surface that is an opposite side of the first main surface; and a resin portion including polypropylene, while exposing both end portions of the lead conductor in a first direction, covering the first main surface, the second main surface, and both side surfaces between the both end portions of the lead conductor, wherein the lead conductor includes a metal substrate made of aluminum or an aluminum alloy, and a colored layer including a black anodic oxide coating formed on a surface of the metal substrate, wherein in an entire wavelength band of 220 nm or more and 850 nm or less, when a total reflectance of barium sulfate is defined as 1.0, a regular reflectance of the black anodic oxide coating is 0.2 or less, and wherein the colored layer is provided on an entirety of the first main surface and the second main surface.

According to the lead member according to another aspect of the present disclosure, when a flaw is formed on the first main surface or the second main surface of the lead conductor, it is easy to find the flaw visually. Also, the colored layer can be easily formed, and the resin portion can be easily heat-fused to the lead conductor, and in a case of being used for a non-aqueous electrolyte battery, it is easy to suppress leakage of an electrolytic solution.

<13> According to yet another aspect of the present disclosure, a lead member includes: a lead conductor having a first main surface and a second main surface that is an opposite side of the first main surface; and a resin portion including polypropylene, while exposing both end portions of the lead conductor in a first direction, covering the first main surface, the second main surface, and both side surfaces between the both end portions of the lead conductor, wherein the lead member includes a metal substrate made of nickel-plated aluminum, a nickel-plated aluminum alloy, nickel-plated copper, or a nickel-plated copper alloy, and a colored layer including a black nickel-plating layer formed on a surface of the metal substrate and having an arithmetic mean peak curvature Spc of 5000 mm⁻¹ or more that is measured in accordance with ISO 25178, wherein in an entire wavelength band of 220 nm or more and 850 nm or less, when a total reflectance of barium sulfate is defined as 1.0, a regular reflectance of the black nickel-plating layer is 0.2 or less and wherein the colored layer is provided on an entirety of the first main surface and the second main surface.

According to the lead member of yet another aspect of the present disclosure, when a flaw is formed on the first main surface or the second main surface of the lead conductor, it is easy to find the flaw visually. Also, the colored layer can be easily formed, and the resin portion can be easily heat-fused to the lead conductor, and in a case of being used for a non-aqueous electrolyte battery, it is easy to suppress leakage of an electrolytic solution.

### DETAILS OF EMBODIMENTS OF THE PRESENT DISCLOSURE

Embodiments of the present disclosure will be described in detail, but the present embodiments are not limited to the specifics as descried. It should be noted that in the specification and the drawings in the present application, the same reference characters are allotted to elements having substantially the same functions such that duplicate descriptions may be omitted. For each drawing, an XYZ orthogonal coordinate system is set for convenience of description.

### First Embodiment

A first embodiment will be described. The first embodiment relates to a lead member. The lead member can be used, for example, as a tab lead for a non-aqueous electrolyte battery such as a lithium ion battery.

[Structure of Lead Member]

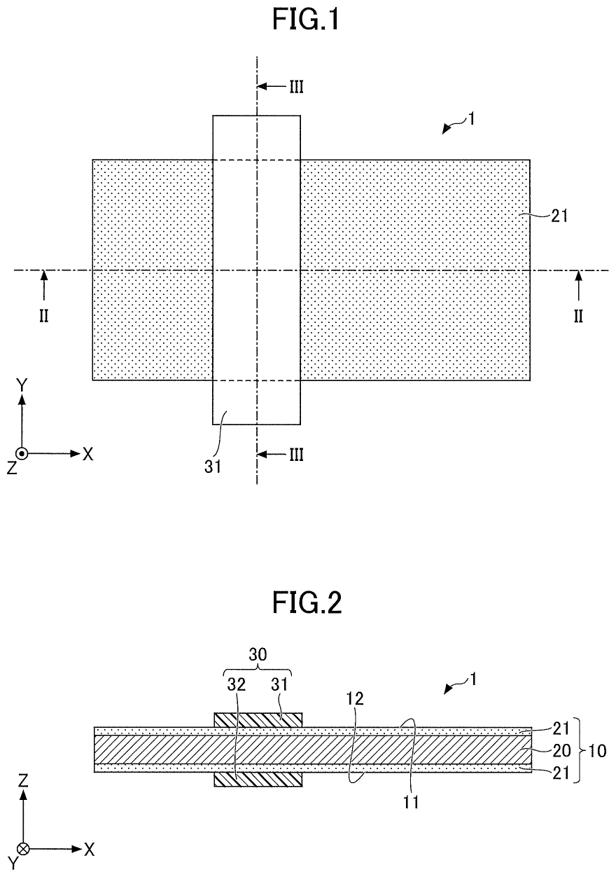

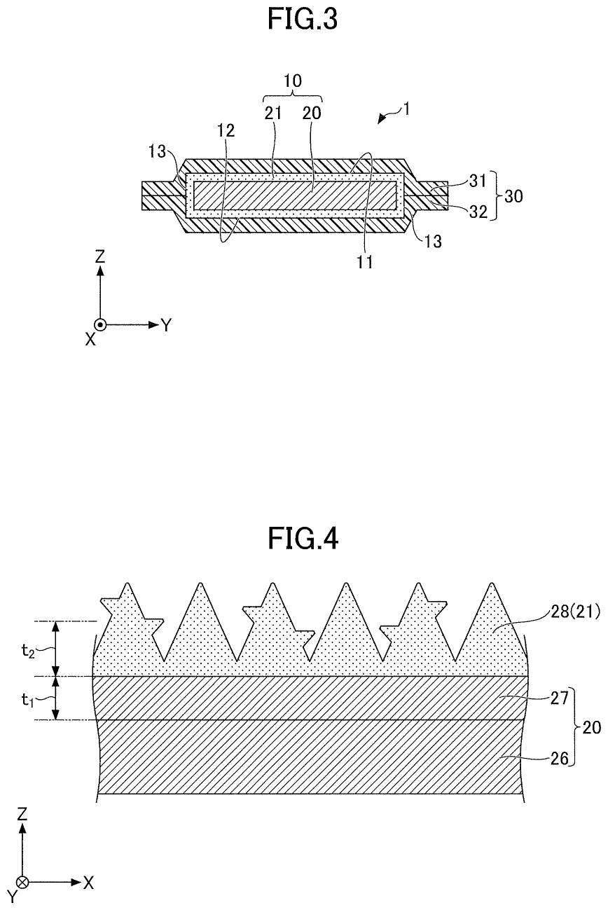

First, a structure of a lead member will be described. FIG. 1 is a plan view illustrating a lead member according to the first embodiment. FIG. 2 and FIG. 3 are cross-sectional views illustrating the lead member according to the first embodiment. FIG. 2 corresponds to a cross-sectional view taken along the line II-II in FIG. 1. FIG. 3 corresponds to a cross-sectional view taken along the line in FIG. 1.

As illustrated in FIG. 1 to FIG. 3, the lead member 1 according to the first embodiment includes a lead conductor 10 and a resin portion 30. The lead conductor 10 has a first main surface 11, a second main surface 12 that is an opposite side of the first main surface 11, and two side surfaces 13 connecting the first main surface 11 and the second main surface 12. The lead conductor 10 includes a metal substrate 20 and a colored layer 21.

The lead conductor 10 has a rectangular planar shape, for example. In the present embodiment, in the planar shape of the lead conductor 10, the direction in which a set of sides parallel to each other extend is defined as the X direction, a direction in which another set of sides parallel to each other extend is defined as the Y direction, and the normal direction of the first main surface 11 is defined as the Z direction. The dimension in the X direction may be larger or smaller than the dimension in the Y direction and may be the same as the dimension in the Y direction. For example, the both side surfaces 13 are perpendicular to the Y direction. The X direction is an example of the first direction.

The lead conductor 10 has a strip-like shape and its dimensions are set as appropriate as needed. For example, the thickness of the lead conductor 10 is 0.05 mm or more and 1.0 mm or less, the length in the X direction is 1 mm or more and 100 mm or less, and the length in the Y direction is 10 mm or more and 100 mm or less.

The metal substrate 20 is made, for example, of aluminum (Al), an aluminum alloy, nickel (Ni), a nickel alloy, copper (Cu), a copper alloy, nickel-plated aluminum, a nickel-plated aluminum alloy, a nickel-plated copper alloy, nickel clad aluminum, a nickel clad aluminum alloy, nickel clad copper or a nickel clad copper alloy, or the like. By using these metallic materials, the lead conductor 10 with good electrical conductivity is easily obtained.

For example, the colored layer 21 covers the entire surface on the first main surface 11 side of the metal substrate 20, the entire surface on the second main surface 12 side of the metal substrate 20, the entire surface on one side surface 13 side of the metal substrate 20, and the entire surface on the other side surface 13 side of the metal substrate 20. In the entire wavelength band of 220 nm or more and 850 nm or less, when the total reflectance of barium sulfate (BaSO₄) is defined as 1.0, the regular reflectance of the colored layer 21 is 0.3 or less, is preferably 0.2 or less, and is more preferably 0.1 or less. When the regular reflectance of the colored layer 21 is greater than 0.3, in a case in which there is a flaw that penetrates the colored layer 21 to reach the lead conductor 10, it is difficult to visually find the flaw.

The regular reflectance is measured as follows. A sample is placed in an integrating sphere with a spherical inner surface and an inner wall made of barium sulfate (BaSO₄), and the sample is irradiated with light of a wavelength band of 220 nm or more and 850 nm or less. Then, the diffuse reflectance (total reflectance) including the regular reflection and the diffuse reflectance (diffuse reflectance itself) not including the regular reflection are obtained, and the regular reflectance is obtained by subtracting the diffuse reflectance from the total reflectance. The reflectance of the wavelength band of 220 nm or more and 850 nm or less is obtained as a reflection spectrum.

In a case in which the metal substrate 20 is made of aluminum or an aluminum alloy, the colored layer 21 may include, for example, an anodic oxide coating of aluminum or an aluminum alloy. An anodic oxide coating is a porous coating that is formed by an anodic oxidation process (alumite process) of aluminum or an aluminum alloy. The anodic oxidation process of aluminum or an aluminum alloy can be carried out using, for example, a sulfuric acid electrolytic solution. By impregnating a dye in the pores of the anodic oxide coating, the color and the regular reflectance of the anodic oxide coating can be adjusted. The anodic oxide coating is preferably a black anodic oxide coating. By using a black anodic oxide coating for the colored layer 21, it is possible to easily form the colored layer 21 that enables to easily find a flaw. The regular reflectance of the black anodic oxide coating is preferably 0.2 or less and is more preferably 0.1 or less in the entire wavelength band of 220 nm or more and 850 nm or less. This is for easily finding a flaw. The thickness of the black anodic oxide coating is preferably 0.5 μm or more and 40.0 μm or less, is more preferably 1.0 μm or more and 30.0 μm or less, and is further more preferably 3.0 μm or more and 15.0 μm or less. It should be noted that the color of the anodic oxide coating is not limited to black. For example, by differentiating the color of the anode oxide coating between the lead member 1 that is used for the positive electrode of an non-aqueous electrolyte battery and the lead member 1 that is used for the negative electrode, it is easier to distinguish them from each other.

In a case in which the metal substrate 20 is made of aluminum, an aluminum alloy, nickel, a nickel alloy, nickel-plated aluminum, a nickel-plated aluminum alloy, nickel-plated copper, a nickel-plated copper alloy, nickel clad aluminum, a nickel clad aluminum alloy, nickel clad copper or a nickel clad copper alloy, the colored layer 21 may include, for example, a black chrome-plating layer. By using a black chrome-plating layer for the colored layer 21, it is possible to easily form the colored layer 21 that enables to easily find a flaw. The black chrome-plating layer can be formed by electrolytic plating using an electrolyte solution containing chromium trioxide (Cr₃O). The regular reflectance of the black chrome-plating layer is preferably 0.2 or less and is more preferably 0.1 or less in the entire wavelength band of 220 nm or more and 850 nm or less. This is for easily finding a flaw. The thickness of the black chrome-plating layer is preferably 0.1 μm or more and 15.0 μm or less, is more preferably 0.5 μm or more and 10.0 μm or less, and is further more preferably 1.0 μm or more and 5.0 μm or less.

In a case in which the metal substrate 20 is made of copper or a copper alloy, the colored layer 21 may include, for example, an anodic oxide coating of copper or a copper alloy. By using an anodic oxide coating of copper or a copper alloy for the colored layer 21, it is possible to easily form the colored layer 21 that enables to easily find a flaw. An anodic oxide coating is formed by an anodic oxidation process of copper or a copper alloy. The anodic oxidation process of copper or a copper alloy can be carried out using, for example, 1 M aqueous potassium (KOH) hydroxide solution with a current density of 3 A/dm². The processing time is, for example, 30 seconds. Immersion in an aqueous solution of benzotriazole (BTA) after the anodic oxidation process can prevent discoloration. The regular reflectance of the anodic oxide coating of copper or a copper alloy is preferably 0.2 or less, and is more preferably 0.1 or less, in the entire wavelength band of 220 nm or more and 850 nm or less. This is for easily finding a flaw. The thickness of the anodic oxide coating of copper or a copper alloy is preferably 0.05 μm or more and 5.0 μm or less, is more preferably 0.1 μm or more and 3.0 μm or less, and is further more preferably 0.2 μm or more and 1.0 μm or less.

In a case in which the metal substrate 20 is made of copper or a copper alloy, the colored layer 21 may include an electroless plating layer of palladium (Pd). When a substrate of copper or a copper alloy is immersed in a plating solution containing palladium ions, due to the difference in ionization tendency, copper ions are eluted from the surface of the substrate and metallic palladium is precipitated on the surface of the substrate to form an electroless plating layer. The electroless plating layer of palladium that is formed in this manner is black. The regular reflectance of the electroless plating layer of palladium is preferably 0.2 or less, and is more preferably 0.1 or less, in the entire wavelength band of 220 nm or more and 850 nm or less. This is for easily finding a flaw. The thickness of the electroless plating layer of palladium is preferably 0.01 μm or more and 1.0 μm or less, is more preferably 0.03 μm or more and 0.5 μm or less, and is further more preferably 0.05 μm or more and 0.3 μm or less.

In a case in which the metal substrate 20 is made of copper or a copper alloy, the colored layer 21 may include a film of sulfide or chloride of copper or a copper alloy.

In a case in which the metal substrate 20 is made of nickel-plated aluminum, a nickel-plated aluminum alloy, nickel-plated copper or a nickel-plated copper alloy, the colored layer 21 may include, for example, a black nickel-plating layer having an arithmetic mean peak curvature Spc of 5000 mm⁻¹ or more. The arithmetic mean peak curvature Spc represents the mean of the main curvatures of the peaks that are present on the surface of an object, and the sharper the peak, the larger the value of the arithmetic mean peak curvature Spc. The arithmetic mean peak curvature Spc can be identified by observation by a measurement method in accordance with ISO 25178 using a laser microscope VK-X110 of KEYENCE CORPORATION and using a 100-fold objective lens under the condition of a magnification of 2,000. In the following, the “arithmetic mean curvature Spc” means the arithmetic mean peak curvature Spc that is measured in accordance with ISO 25178 at the time of observation using a laser microscope VK-X110 of KEYENCE CORPORATION and using a 100-fold objective lens under the condition of a magnification of 2,000, unless otherwise specified.

FIG. 4 is a schematic diagram illustrating a black nickel-plating layer. In the example illustrated in FIG. 4, the metal substrate 20 includes a copper foil 26 and a nickel-plating layer 27 formed on the surface of the copper foil 26. For example, the thickness of the copper foil 26 is 0.2 mm, the thickness t₁ of the nickel-plating layer 27 is 0.1 μm or more and 1.0 μm or less, and the thickness t₂ of a black nickel-plating layer 28, which is used as the colored layer 21, is 0.1 μm or more and 3.0 μm or less. The flatness of the copper foil 26 and the nickel-plating layer 27 is high, and the arithmetic mean curvature Spc of the copper foil 26 and the nickel-plating layer 27 is less than or equal to 4000 mm⁻¹. In contrast, the black nickel-plating layer 28 has an arithmetic mean curvature Spc of 5000 mm⁻¹ or more, has a large curvature of peak, and has a low flatness. It should be noted that the thickness t of the copper foil 26, the thickness t₁ of the nickel-plating layer 27, and the thickness t₂ of the black nickel-plating layer 28 are each the average thicknesses.

By using a black nickel-plating layer having an arithmetic mean curvature Spc of 5000 mm⁻¹ or more for the colored layer 21, the colored layer 21 that enables to easily find a flaw can be easily formed. The arithmetic mean curvature Spc of the black nickel-plating layer included in the colored layer 21 is more preferably 10,000 mm⁻¹ or more, and is more preferably 15,000 mm⁻¹ or more. The regular reflectance of the black nickel-plating layer is preferably 0.2 or less, and is more preferably 0.1 or less, in the entire wavelength band of 220 nm or more and 850 nm or less. This is for easily finding a flaw. The average thickness of the black nickel-plating layer is preferably 0.1 μm or more and 3.0 μm or less, is more preferably 0.3 μm or more and 2.0 μm or less, and is further more preferably 0.5 μm or more and 1.5 μm or less.

A black nickel-plating layer of which the arithmetic mean curvature Spc is 5000 mm⁻¹ or more can be formed, for example, by electroplating with a plating solution containing nickel chloride hexahydrate, boric acid, ethylenediamine dihydrochloride (EDA.HCl), and a pH adjuster. For example, the contents of nickel chloride hexahydrate, boric acid, and EDA.HCl per 1 L of plating solution are respectively 100 g or more and 300 g or less, 5 g or more and 100 g or less, and 50 g or more and 400 g or less, and the pH of the plating solution is 3.0 or more and 5.0 or less.

While exposing both end portions of the lead conductor 10 in the X axis direction, the resin portion 30 covers the first main surface 11, the second main surface 12, and both side surfaces 13 between the both end portions. Except the areas including the both end portions of the lead conductor 10 in the X direction, the resin portion 30 is arranged to cover the outer peripheral sides of a portion in the X direction. Accordingly, the colored layer 21 is provided at least between the metal substrate 20 and the resin portion 30. Because the both end portions of the lead conductor 10 in the X direction are electrically connected to conductive portions such as electrodes or terminals, the both end portions are exposed and on which the resin portion 30 is not provided. The resin portion 30 includes, for example, resin films 31 and 32 that are bonded together to sandwich the lead conductor 10. The dimension of the resin films 31 and 32 in the Y direction is larger than the dimension of the lead conductor 10 in the Y direction, thereby increasing the sealing performance. For example, the thickness of the resin films 31 and 32 is 30 μm or more and 300 μm or less, the length in the X direction is 2 mm or more and 20 mm or less, and the length in the Y direction is 3 mm or more and 150 mm or less. The resin film 31 is provided on the first main surface 11, and the resin film 32 is provided on the second main surface 12.

The resin films 31 and 32 are, for example, resin articles made of a resin composition including polypropylene (PP). Although a method of manufacturing the lead member 1 will be described later, by including polypropylene in the resin portion 30, the resin portion 30 is easily heat-fused to the lead conductor 10. It should be noted that the form of a resin article is not necessarily a form of a film. For example, it may be a seamless resin portion that is formed by applying or extruding a resin composition to the periphery of the lead conductor 10. In a case in which a film is used, a single film may be wound around the lead conductor 10 to form the resin portion 30.

In FIG. 2 and FIG. 3, although each of the resin films 31 and 32 is illustrated as a single layer structure, a layered body containing a plurality of resin films may be used in place of the single-layer resin films 31 and 32. For example, as the resin films 31 and 32, it is possible to use a dual-layer structure in which a first layer made of a polyolefin resin such as maleic anhydride-modified low-density polyethylene (PE) or polypropylene (PP) and a second layer made of a polyolefin resin such as low-density polyethylene are bonded together.

In the lead member 1 according to the first embodiment, the colored layer 21 having a regular reflectance of 0.5 or less when the total reflectance of barium sulfate (BaSO4) is defined as 1.0 is formed on the surface of the metal substrate 20 of the lead conductor 10. Therefore, when a flaw is formed on the colored layer 21, the flaw can be easily found visually. Also, while the lead member 1 may be used with laser welding, the colored layer 21 having a regular reflectance of 0.5 or less easily absorbs laser light. Thus, a good weldability can also be obtained. Further, the lead member 1 may be used in contact with an electrolyte solution, the colored layer 21 may enhance the corrosion resistance of the lead conductor 10. In particular, in a case in which the electrolyte solution contains hydrofluoric acid, the enhancement of corrosion resistance is suitable for extending the life of the lead conductor 10.

Also, because the colored layer 21 is disposed between the metal substrate 20 and the resin portion 30, in a case of being used in a non-aqueous electrolyte cell, an electrolyte solution does not easily penetrate between the metal substrate 20 and the resin portion 30. Therefore, the leakage of the electrolyte solution is easily suppressed.

Although the colored layer 21 need not be provided on the entirety of the first main surface 11 and the second main surface 12, in a case in which the colored layer 21 is provided on the entirety of the first main surface 11 and the second main surface 12, it is easy to find a flaw over a wide area of the lead conductor 10.

[Method of Manufacturing Lead Member]

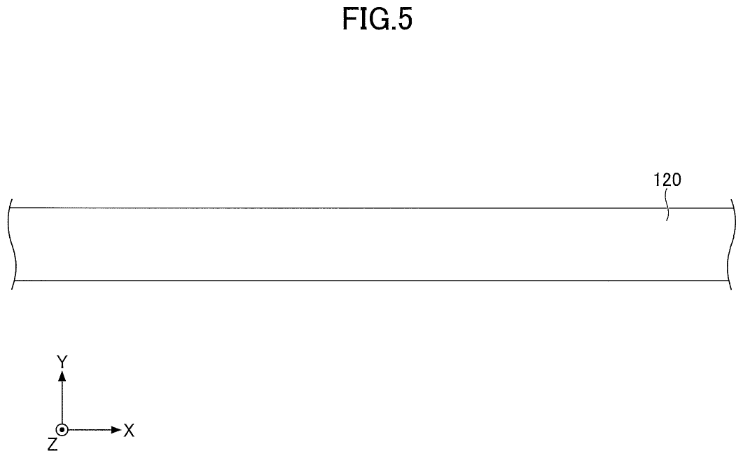

Next, a method of manufacturing the lead member 1 will be described. FIG. 5 to FIG. 8 are plan views illustrating the method of manufacturing the lead member 1 according to the first embodiment.

First, as illustrated in FIG. 5, a metal tape 120 is prepared. The metal tape 120 later becomes the metal substrate 20. The metal tape 120 is made, for example, of aluminum (Al), an aluminum alloy, nickel (Ni), a nickel alloy, copper (Cu), a copper alloy, nickel-plated aluminum, a nickel-plated aluminum alloy, nickel-plated copper, a nickel-plated copper alloy, nickel clad aluminum, a nickel clad aluminum alloy, nickel clad copper or a nickel clad copper alloy, or the like.

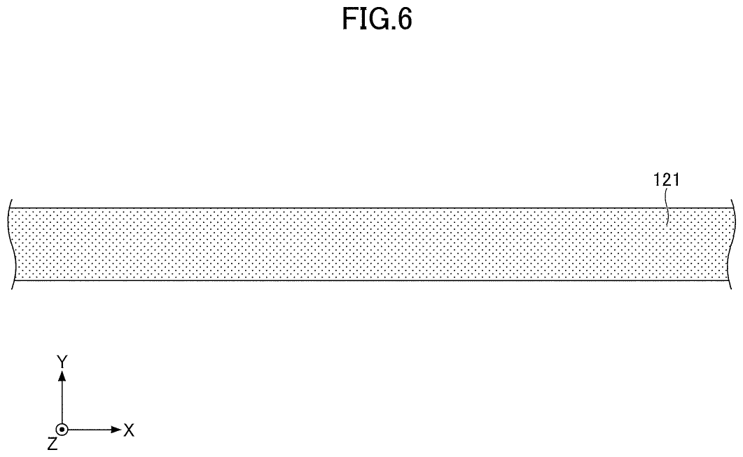

Then, as illustrated in FIG. 6, a colored layer 121 is formed on the surface of the metal tape 120. The colored layer 121 later becomes the colored layer 21. In a case in which the metal tape 120 is made of aluminum or an aluminum alloy, for example, by forming a porous anodic oxide coating (an alumite coating) by an anodic oxidation process and impregnating a dye in the pores of the anodic oxide coating, the colored anodic oxide coating can be formed as the colored layer 121. In a case in which the metal tape 120 is made of aluminum, an aluminum alloy, nickel, a nickel alloy, nickel-plated aluminum, a nickel-plated aluminum alloy, nickel-plated copper, a nickel-plated copper alloy, nickel clad aluminum, a nickel clad aluminum alloy, nickel clad copper or a nickel clad copper alloy, a black chrome-plating layer can be formed as the colored layer 121 by, for example, electroplating using an electrolytic solution containing chromium trioxide (Cr₃O). In a case in which the metal tape 120 is made of copper or a copper alloy, an anodic oxide coating can be formed as the colored layer 121, for example, by an anodic oxidation process. In a case in which the metal tape 120 is made of nickel-plated aluminum, a nickel-plated aluminum alloy, nickel-plated copper or a nickel-plated copper alloy, a black nickel-plating layer can be formed as the colored layer 121, for example, by electroplating with a plating solution containing nickel chloride hexahydrate, boric acid, ethylenediamine dihydrochloride (EDA.HCl), and a pH adjuster.

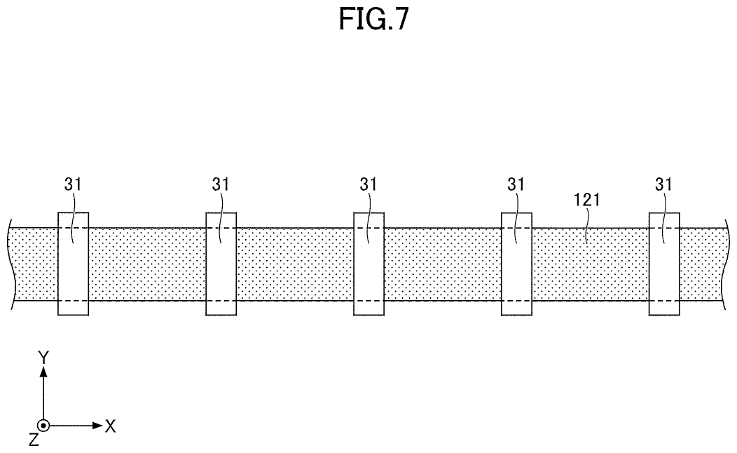

Next, as illustrated in FIG. 7, a plurality of sets of resin films 31 and 32 are prepared, and the resin films 31 and 32 are bonded together such that the metal tape 120 on which the colored layer 121 is formed is interposed therebetween. Then, the metal tape 120 on which the colored layer 121 is formed and the resin films 31 and 32 are sandwiched between an upper head and a lower head of a hot press machine, and by heat pressing, the resin films 31 and 32 are heat-fused to the metal tape 120 on which the colored layer 121 is formed. This process is performed at regular intervals for the metal tape 120. In this manner, a continuous lead member is obtained.

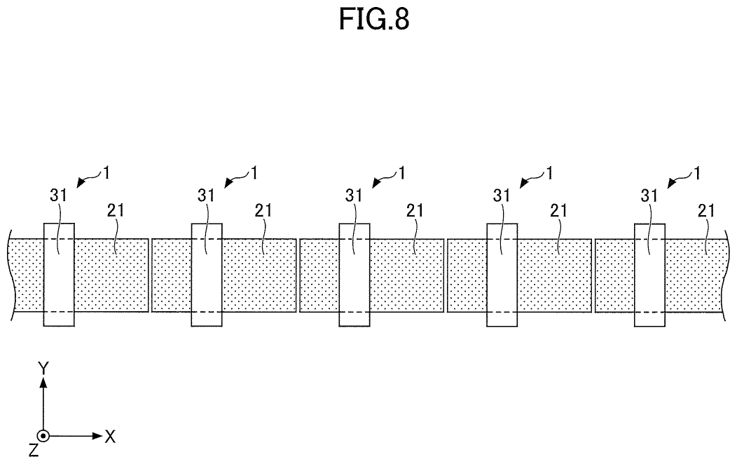

The continuous lead member is then cut between adjacent sets of resin films 31 and 32, as illustrated in FIG. 8. In this manner, a plurality of lead members 1 can be obtained.

### Second Embodiment

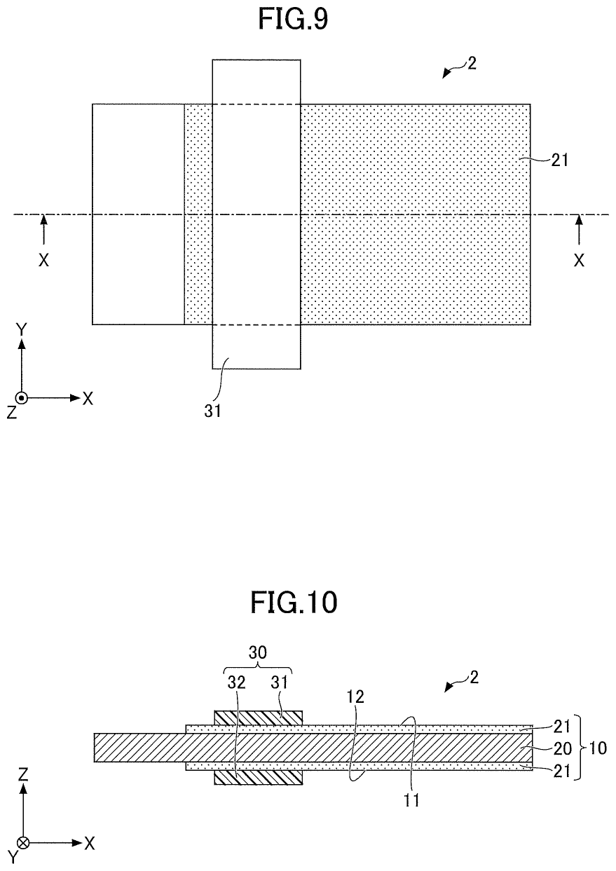

A second embodiment will be described. The second embodiment differs from the first embodiment mainly in the range where the colored layer is formed. FIG. 9 is a plan view illustrating a lead member according to the second embodiment. FIG. 10 is a cross-sectional view illustrating the lead member according to the second embodiment. FIG. 10 corresponds to a cross-sectional view taken along the X-X line in FIG. 9.

As illustrated in FIG. 9 and FIG. 10, in a lead member 2 according to the second embodiment, in the X direction, on one end side (+X side) relative to the resin portion 30, the colored layer 21 covers the entire surface on the first main surface 11 side of the metal substrate 20, the entire surface on the second main surface 12 side of the metal substrate 20, the entire surface on one side surface 13 side of the metal substrate 20, and the entire surface on the other side surface 13 side of the metal substrate 20. The colored layer 21 is also provided between the resin portion 30 and the metal substrate 20. In the X direction, on the other end side (−X side) relative to the resin portion 30, the colored layer 21 covers a part of the surface on the first main surface 11 side of the metal substrate 20, a part of the surface on the second main surface 12 side of the metal substrate 20, a part of the surface on one side surface 13 side of the metal substrate 20, and a part of the surface on the other side surface 13 side of the metal substrate 20. Accordingly, a part of the metal substrate 20 is exposed from the colored layer 21 on the other end side (−X side) relative to the resin portion 30.

Other configurations are similar to those of the first embodiment.

The colored layer 21 is mainly provided for easily finding a flaw visually. After the inspection for presence/absence of a flaw is completed, a part of the colored layer 21 may be removed so that a part of the metal substrate 20 is exposed, as in the second embodiment. For example, a portion at one end side (+X side) relative to the resin portion 30 of the lead conductor 10 is housed in an inclusion body, and a portion at the other end side (−X side) is connected to a load or the like outside the inclusion body. A plurality of portions on the other end side (−X side) may be welded.

Although the embodiments have been described in detail above, it is not limited to a specific embodiment. Various modifications and changes can be made within a scope set forth in the claims.

### DESCRIPTION OF THE REFERENCE NUMERALS

1, 2: lead member
10: lead conductor
11: first main surface
12: second main surface
13: side surface
20: metal substrate
21: colored layer
26: copper foil
27: nickel-plating layer
28: black nickel-plating layer
30: resin portion
31: resin film
32: resin film
120: metal tape
121: colored layer

1. A lead member comprising:
a lead conductor having a first main surface and a second main surface that is an opposite side of the first main surface; and
a resin portion, while exposing both end portions of the lead conductor in a first direction, covering the first main surface, the second main surface, and both side surfaces between the both end portions of the lead conductor,
wherein the lead conductor includes
a metal substrate, and
a colored layer formed on at least a portion of a surface of the metal substrate,
wherein in an entire wavelength band of 220 nm or more and 850 nm or less, when a total reflectance of barium sulfate is defined as 1.0, a regular reflectance of the colored layer is 0.3 or less.

2. The lead member according to claim 1, wherein the metal substrate includes aluminum, an aluminum alloy, nickel, a nickel alloy, copper, a copper alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy.

3. The lead member according to claim 2,
wherein the metal substrate is made of aluminum or an aluminum alloy, and
wherein the colored layer includes a black anodic oxide coating.

4. The lead member according to claim 3, wherein in the entire wavelength band of 220 nm or more and 850 nm or less, when the total reflectance of the barium sulfate is defined as 1.0, a regular reflectance of the black anodic oxide coating is 0.2 or less.

5. The lead member according to claim 2,
wherein metal substrate is made of nickel-plated aluminum, a nickel-plated aluminum alloy, nickel-plated copper, or a nickel-plated copper alloy, and
wherein the colored layer includes a black nickel-plating layer having an arithmetic mean peak curvature Spc of 5000 mm⁻¹ or more that is measured in accordance with ISO 25178.

6. The lead member according to claim 5, wherein in the entire wavelength band of 220 nm or more and 850 nm or less, when the total reflectance of the barium sulfate is defined as 1.0, a regular reflectance of the black nickel-plating layer is 0.2 or less.

7. The lead member according to claim 2,
wherein the metal substrate is made of nickel, a nickel alloy, nickel-plated aluminum, a nickel-plated aluminum alloy, nickel-plated copper, a nickel-plated copper alloy, nickel clad aluminum, a nickel clad aluminum alloy, nickel clad copper, or a nickel clad copper alloy, and
wherein the colored layer includes a black chrome-plating layer.

8. The lead member according to claim 7, wherein in the entire wavelength band of 220 nm or more and 850 nm or less, when the total reflectance of the barium sulfate is defined as 1.0, a regular reflectance of the black chrome-plating layer is 0.2 or less.

9. The lead member according to claim 1, wherein the colored layer is provided at least between the metal substrate and the resin portion.

10. The lead member according to claim 1, wherein the colored layer is provided on an entirety of the first main surface and the second main surface.

11. The lead member according to claim 1, wherein the resin portion includes polypropylene.

12. A lead member comprising:
a lead conductor having a first main surface and a second main surface that is an opposite side of the first main surface; and
a resin portion including polypropylene, while exposing both end portions of the lead conductor in a first direction, covering the first main surface, the second main surface, and both side surfaces between the both end portions of the lead conductor,
wherein the lead conductor includes
a metal substrate made of aluminum or an aluminum alloy, and
a colored layer including a black anodic oxide coating formed on a surface of the metal substrate,
wherein in an entire wavelength band of 220 nm or more and 850 nm or less, when a total reflectance of barium sulfate is defined as 1.0, a regular reflectance of the black anodic oxide coating is 0.2 or less, and
wherein the colored layer is provided on an entirety of the first main surface and the second main surface.

13. A lead member comprising:
a lead conductor having a first main surface and a second main surface that is an opposite side of the first main surface; and
a resin portion including polypropylene, while exposing both end portions of the lead conductor in a first direction, covering the first main surface, the second main surface, and both side surfaces between the both end portions of the lead conductor,
wherein the lead member includes
a metal substrate made of nickel-plated aluminum, a nickel-plated aluminum alloy, nickel-plated copper, or a nickel-plated copper alloy, and
a colored layer including a black nickel-plating layer formed on a surface of the metal substrate and having an arithmetic mean peak curvature Spc of 5000 mm⁻¹ or more that is measured in accordance with ISO 25178,
wherein in an entire wavelength band of 220 nm or more and 850 nm or less, when a total reflectance of barium sulfate is defined as 1.0, a regular reflectance of the black nickel-plating layer is 0.2 or less and
wherein the colored layer is provided on an entirety of the first main surface and the second main surface.
